(19) United States
(12) Patent Application Publication
(10) Pub. No.: US 2011/0179045 A1
(43) Pub. Date: Jul. 21, 2011

(54) Template-Based Management and Organization of Events and Projects

(75) Inventors: Nicholas Caldwell, Bellevue, WA (US); Venkat Pradeep Chilakamarri, Redmond, WA (US); Saliha Azzam, Redmond, WA (US); Benjamin Edward Childs, Seattle, WA (US); Bernhard SJ Kohlmeier, Woodinville, WA (US); Jonathan C. Ludwig, Kirkland, WA (US); Kimberly Manis, Seattle, WA (US); Courtney Anne O'Keefe, Bellevue, WA (US); Diego Perez Del Carpio, Redmond, WA (US); Tu Huy Phan, Redmond, WA (US); Kevin Powell, Kirkland, WA (US); Jignesh Shah, Bellevue, WA (US); Ashish Sharma, Bellevue, WA (US)

(73) Assignee: Microsoft Corporation, Redmond, WA (US)

(21) Appl. No.: 12/818,746

(22) Filed: Jun. 18, 2010

Related U.S. Application Data
(60) Provisional application No. 61/296,343, filed on Jan. 19, 2010.

(51) Int. Cl. G06F 17/30

(52) U.S. Cl. 707/754; 707/802; 707/E17.059

(57) ABSTRACT

A space in which a user may organize data and collaborate with other users is provided. Project data and metadata may be saved into a reusable template and stored in a repository, wherein other users may discover and download the template for use as a resource for a related project type. A template may contain various document types that may expose a breadth of applications and application functionalities that may be utilized for a given task or project. Questions and answers, task templates, and terminology may also be provided. Project templates may allow for collaboration on projects, wherein business and/or social groups may collaborate quickly, easily, and more completely.

### CROSS REFERENCE TO RELATED APPLICATIONS

This application claims benefit under 35 U.S.C. §119(e) of U.S. Provisional Patent application Ser. No. 61/296,343 entitled “Aggregating and Presenting Associated Information (Huddle)” and filed on Jan. 19, 2010, the entirety of which is incorporated by reference herein.

### BACKGROUND

When a person is engaged in or is about to undertake a task or project with which he/she may have little or no prior experience, he/she may start the task or project almost in a vacuum. Many times, the task or project has been completed by other people who may have resources and knowledge gained from their experience with the task or project, but these resources may not be readily accessible to others. For example, it may benefit a person who is planning a wedding for the first time to have to-do lists, contact information for events facilities, caterers, musicians, etc., as well as many other wedding planning resources from someone who has planned a wedding recently. Oftentimes, when someone completes a project, such as planning a wedding, the knowledge and resources gained from the experience are not passed on or shared.

It is with respect to these and other considerations the present invention has been made.

### SUMMARY

Embodiments of the present invention solve the above and other problems by providing a work space in which a user may organize data and collaborate with other users. Templates may be provided which may contain various document types that may expose a breadth of applications and application functionalities that may be utilized for a given project or task. Preformatted examples with questions and answers and terminology may also be provided. Embodiments of the present invention may allow for collaboration on projects, wherein social groups may collaborate quickly, easily, and more completely.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The accompanying drawings, which are incorporated in and constitute a part of this disclosure, illustrate various embodiments of the present invention. In the drawings:

FIG. 1A is a block diagram of an operating environment of a project data aggregation and management (PDAM) application;

FIG. 1B is a block diagram of an operating environment for providing a reusable package of project data and metadata.

FIG. 2 is a flow chart of a method for utilizing a template;

FIG. 3 is a flow chart of a method for saving a template; and

FIG. 4 is a block diagram of a system including a computing device with which embodiments of the invention may be practiced.

### DETAILED DESCRIPTION

Embodiments of the present invention are directed to providing a work space in which a user may organize data and collaborate with other users. Project data and metadata may be saved into a reusable template and stored in a repository wherein other users may discover and download the template for use as a resource for a related project type.

The following description refers to the accompanying drawings. Whenever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Referring now to the drawings, in which like numerals represent like elements through the several figures, aspects of the present invention and the exemplary operating environment will be described. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

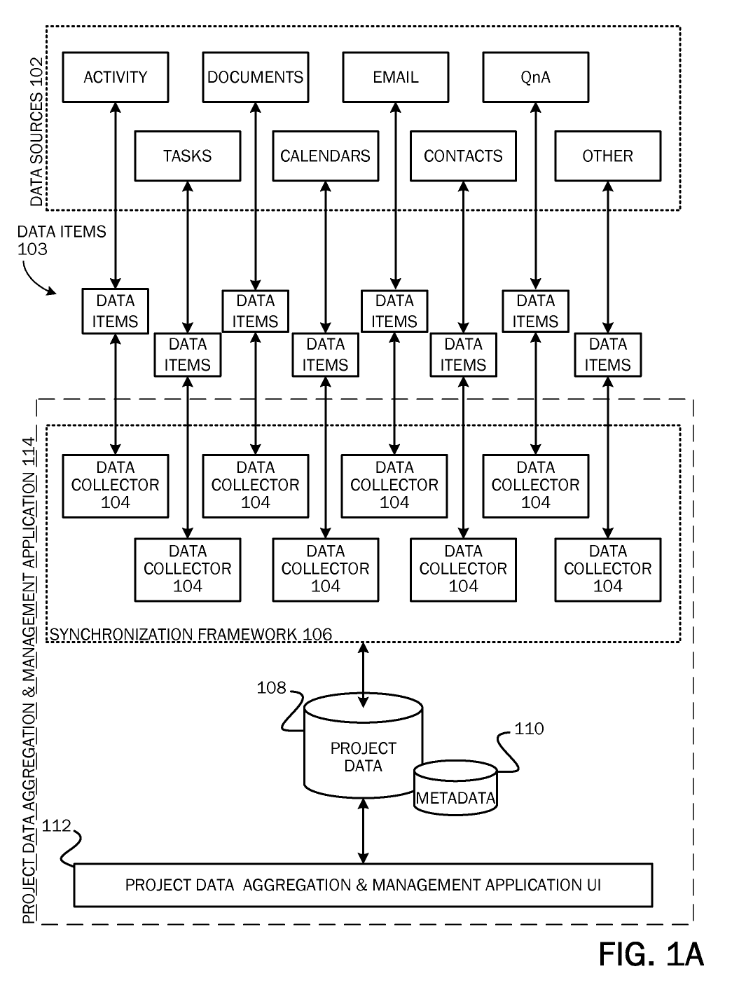

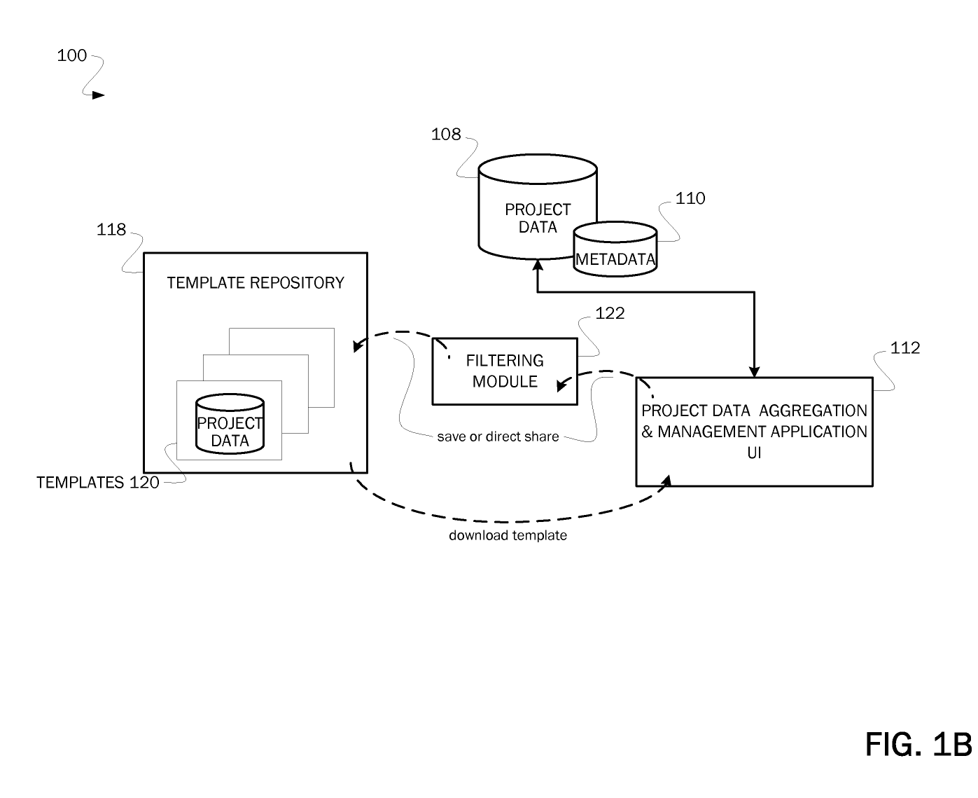

As briefly described above, embodiments of the present invention are directed to a work space in which a user may organize data and collaborate with other users. FIG. 1A lays out a system framework of a project data aggregation and management (PDAM) application 114, within which embodiments of the present invention may be incorporated.

FIG. 1A is a simplified block diagram of a system architecture for embodiments of a PDAM application 114. Embodiments of the PDAM application may be utilized as a tool to aggregate and manage project data. Referring now to FIG. 1A, data items 103 may be provided. Data items 103 may be of various content types, and may be from various data sources 102. Data sources 102 may include, but are not limited to, activities, documents, electronic mail, questions and answers, tasks, calendars, and contacts, or any other electronic data from which data relevant to a one or more projects may be retrieved. Data items 103 may be located within a local file system, within a web-based content management system, such as SHAREPOINT by MICROSOFT CORPORATION of Redmond, Wash., or located remotely and linked through a communications network. In a distributed computing environment, data items 103 may be located in both local and remote memory storage devices. A data item 103 may be, for example, a calendar item, a contact item, an electronic mail (“email”) communication, a task item, a term, an electronic document (e.g., word processing document, spreadsheet document, slide presentation document, etc.), photographic files, audio files, or any other item of data that may be relevant to one or more projects of interest.

Embodiments of the present invention may comprise a synchronization framework 106, which is a framework of data collection interfaces 104, herein referred to as data collectors. A data collector 104 is an interface that may communicate with one or more data sources 102, and pull various data items 103 that may contain relevant information to a project from the data source 102. A project may be created by a user within a PDAM application 114. When a project is created, a title and description may be given to the project, which may be used as metadata 110 for discovering content that may be of relevance to the project. Data collectors 104 may search for content locally and from external repositories. Discovered content may be suggested to a user, wherein the user may accept a suggested piece of content and that data item 103 may be extracted and stored into a project data store 108. According to an embodiment, a data item 103 may be extracted and stored into a project data store 108 without user interaction.

Information that is exchanged between a data source 102 and a data collector 104 may be customizable. For example, if the data source 102 is an electronic mail application, electronic calendar application, electronic task application, or an application that provides combined resources of these applications, for example, OUTLOOK by MICROSOFT CORPORATION of Redmond, Wash., a data collector 104 may be implemented to interface the email application so that it may be operative for discovering data and metadata of an email. As should be appreciated, there may be multiple extraction points of a data source 102. Accordingly, there may be multiple data collectors 104 for a data source 102. In addition, there may be multiple data items 103 extracted or suggested from a data source 102. Considering the above example, where the data source 102 is an electronic mail application, electronic calendar application, electronic task application, or combination functionality application, one data collector 104 may be implemented to discover email data, and another data collector 104 may be implemented to discover calendar data, and another to discover task data, etc. A data collector 104 may know not only where to get data, but also how and what type of data to retrieve.

As new data sources 102 are added to a project, a synchronization framework 106 may implement new data collector 104 interfaces. For every possible type of collection, an implementation of that interface may be added to the synchronization framework 106. The synchronization framework 106 may pull in data as well as push data back out to a data source 102. Data may be pulled in via one of two modes. According to a first mode, a data source 102 may be checked for new content according to a specified time interval. For example, a data source 102 may be checked every thirty (30) seconds to see if there is new data available. With some data sources 102, it may be inefficient to pull data in such a manner. By utilizing a subscriber-type model, a data source 102 may notify the synchronization framework 106 when a change occurs. Consider, for example, that a data collection, organization and sharing application, for example, SHAREPOINT by MICROSOFT CORPORATION is a data source 102 for a project. The application may use very large lists to transfer data. The list may have thousands of elements, so it would be inefficient to pull them and check a thousand elements every thirty (30) seconds for new data. Accordingly, a second mode may be utilized to check for new data. The synchronization framework 106 may register for an event, wherein the synchronization framework 106 may be notified when a change has occurred.

As data items 103 that are of relevance to a project are pulled from a data source 102 by a data collector, that data may be stored in a project data store 108. The project data store 108 is a data repository or organizational knowledge base, and may be available to and access by others. Data collectors 104 may put data into a project data store 108 in whatever way may be most efficient for the system. For example, if document information is being collected, that data may be put into the data store 108 by downloading the document and associating the whole document with the project. Alternatively, instead of downloading the full document, a link to the document may be downloaded; and, the link information may be tagged with a last modification date. In the same way that various forms of data may be collected from a variety of aggregation points, the way the data is stored internally can vary. Project data 108 may be a collection of identifications to actual data that may be stored locally or in disparate locations. Data may comprise project related content as well as contact information, and any other available content that may be relevant to a project. A project data store 108 may also comprise metadata 110, such as a title, description, other people who may be joined and working on a project, security descriptors, comments, category tags, types of content that should be stored within a project, and how it should be displayed in a user interface 112.

According to one embodiment, data may be stored in a data base table, for example a structured query language (SQL) data table. After a project data store 108 is created, all associated content may be added into the data store. The content may consist of a generic wrapper that provides a name, an identifier, a creation date, and other pieces of metadata along with payloads, which consist of the actual data or links to the actual data. For example, if a user adds a contact to a project, a wrapper may be created that may contain a title of the contact, a date it was created, etc., and a payload. For a contact, the payload would be the unique identifier of the user who is being added as a contact. For every type of content within a project, a wrapper and payload exists.

According to an embodiment, a PDAM application project may coexist with other more highly-structured enterprise projects. The other more highly-structured enterprise projects may be associated with data, data sources and projects spanning organizations and entities of varying sizes and structures. A PDAM application project may pull information from the other more highly-structured projects. According to embodiments, the other more highly-structured projects may contain or include information from PDAM application projects. An overall project system may manage these deliverables or PDAM application projects.

A PDAM application user interface (UI) 112 is a modular user interface that may display data items 103 from multiple data sources 102. For example, a PDAM application UI 112 may display data items 103 like calendar data, emails, tasks, etc. as well as any other type of data, such as word processing documents, spreadsheet documents, presentation documents, and social networking correspondences. The PDAM application UI 112 may borrow functionality of one or more applications, such as an electronic mail application, electronic calendar application, electronic task application, or an application that provides combined resources of these applications for displaying and interacting with calendar, task and email items. The PDAM application UI 112 may also extend functionalities of other applications so that it may display other relevant project information along with those functionalities.

Within a PDAM application UI 112, a notification system may be provided. According to an embodiment, when a data collector 104 retrieves a data item 103 from a data source 102, a user may be notified through the PDAM application UI 112 that new information is available, so that the user may then act on it. For example, a person in a project may upload a new document relative to the project. Other members in the project may need to know that a new document has been uploaded. The other users may receive a notification that a new activity is available.

According to another embodiment, a user may publish new data through the PDAM application UI 112 that can be sent out to various data sources 102. For example, if a user has a project linked to various communication sources, such as email, instant messaging, and one or more social networks, for example, FACEBOOK or TWITTER, the user may push content back out to one or more of those communication sources. The user may create an email or text message or other suitable messaging form from within the PDAM application UI 112. The PDAM application UI 112 may act as an aggregator of content as well as a way to push content back out to any desired recipient user or recipient system.

Having described a system framework of a project data aggregation and management (PDAM) application 114 with which embodiments of the present invention may be incorporated, FIG. 1B is a simplified block diagram of an operating environment 100 for providing a reusable package of project data and metadata. Referring now to FIG. 1B, an illustrative operating environment 100 for providing a space in which a user may organize data and collaborate with other users is provided. A project data store 108 may store project data, metadata 110, such a title, description, etc. of a piece of project data, as well as metadata 110 about the types of content that should be stored within a project and how it should be displayed in a user interface 112.

Project data and metadata 110 stored within a project data store 108 may be saved in a template repository 118. A template repository 118 may store template packages 120, wherein a user may search, browse, and discover the template packages. The template repository 118 may be located within a local file system, within a web-based content management system, such as SHAREPOINT by MICROSOFT CORPORATION of Redmond, Wash., or may be located remotely and linked through a communications network. In a distributed computing environment, template repository 118 may be located in both local and remote memory storage devices.

According to embodiments, a template 120 is application agnostic, meaning that the template may not be tied to a particular application, but may be associated with the functionality of one or more disparate software applications. That is, individual items of project data inside a template may be associated with various applications (e.g., a template may contain a MICROSOFT WORD document and a TWITTER feed URL). Accordingly, the template, as a whole, may not be associated with only one application. The template 120 may contain various document types, and may help a user to discover an application or application functionality to use for a specific task. A template 120 may also contain questions and answers, task templates, and terminology.

A user interface 112 may communicate with the template repository 118, wherein a template 120 may be downloaded and saved into a local repository 108. The project data and metadata 110 contained within the template 120 may be utilized as a starting point for a new project. According to another embodiment, project data and metadata 110 stored in a project data store 108 may be saved into a template 120 and put into a template repository 120 so that it may be shared with other users.

For purposes of explanation of embodiments of the invention, two example use cases follow. As should be appreciated the use cases are for purposes of example, explanation and understanding only and are not limiting of the invention as claimed. Consider, then, the following first example use case. A home user, Mary, has a friend, Susan, who is engaged to be married. As the maid of honor, Mary has volunteered to help Susan plan the wedding. Mary creates a project for the wedding plans utilizing a project data aggregation and management application, and invites Susan and her fiancée to join. In the project data aggregation and management application (herein referred to as PDAM application), they are able to manage their guest list and gift registries in spreadsheets.

Continuing with the example, Susan and her fiancée may collaborate on these documents, making sure both of their families and friends are included and that they have selected all the gifts they will need. They also keep track of contact information for flower vendors and caterers that they are interested in meeting with. As Mary sets up appointments with each vendor, she stores the meeting information in the PDAM application so that Susan can keep track of all their appointments. They keep all their notes and opinions on each vendor in one place so they can compare them and make the best choices. Once they begin making decisions about the wedding, they create a budget to track all of the expenses. Susan creates invitations for the wedding, as well as the bridal shower and rehearsal dinner. After sending out the invitations, Susan and Mary need to track RSVPs and gifts received. They use the RSVP list to create seating arrangements for the wedding. On the day of the wedding, Mary can use the PDAM application as a reference on her mobile phone in case she needs to call any of the vendors or check where guests should be seated. After the wedding, Susan writes thank you notes to all of her guests that attended. When her friend gets engaged later that year, Susan sends her the wedding Template 120 and associated project data to make planning a little bit easier. According to embodiments, the template 120 may contain project data and metadata 110 associated with various applications, for example, MICROSOFT OFFICE applications such as OUTLOOK for tasks, electronic mails (emails), contacts, and scheduling data, EXCEL and PUBLISHER for gift tracking and for creating thank you cards, ONENOTE for keeping notes on meetings, and VISIO for creating seating charts.

Consider now a second use case as follows. James works as a real estate agent. He covers several neighborhoods in Seattle, as well as Redmond. Sarah, a prospective buyer, is moving to Washington State and is unsure of which neighborhood to live in. After speaking with Sarah about her requirements, James sends Sarah several project templates 120 that his business maintains, each outlining a different neighborhood. The project templates contain all the listings for homes in each neighborhood. They also contain commonly requested information, such as details about the schools in the area, crime rates, and public transportation. Sarah can ask any questions she did not have answered directly in a PDAM interface. After narrowing down the neighborhoods, Sarah asks James to take her to several listings she viewed in the Redmond template 120. While visiting the homes, Sarah takes notes on her mobile phone on each listing. When she gets home, Sarah goes through the PDAM interface and reviews her notes. After much debate, she settles on a home and asks James to begin preparing the purchase paperwork. James puts all of the forms required into the PDAM application and generates an appropriate template 120 with which Sarah may utilize needed project data and application functionality. Sarah also uses the PDAM application to manage her correspondence with her bank while she is applying for a mortgage.

The above example scenario may utilize various templates 120 which may include neighborhood information, which may contain information and contacts regarding schools, crime statistics, transportation, etc. Neighborhood information may also include statistics and other information found on the Web. A discussion board may also be provided, as well as legal documents, financial documents, etc.

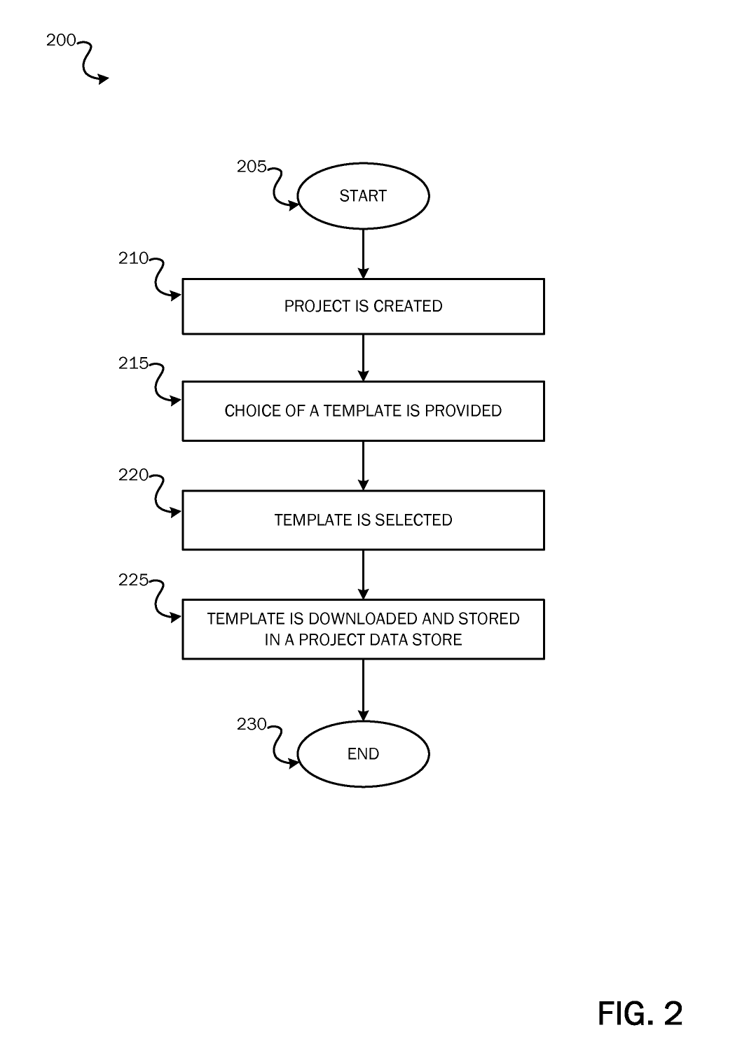

Referring now to FIG. 2, a process flow diagram of a method 200 for utilizing a template 120 in a new project will be described. The method starts at OPERATION 205, and proceeds to OPERATION 210, where a project is created, for example, the example wedding or real estate projects described above. According to embodiments, a user may create a project within a project data aggregation and management application (PDAM application), wherein the user may input a title and description of the project.

Once a project is created, the method proceeds to OPERATION 215, where a choice of a template 120 is provided. Templates 120 may be saved in a template repository 118. A template may be suggested to a user based on metadata associated with the project (e.g., title, description, etc.). At OPERATION 220, a template 120 is selected via one of various selection mechanisms, and at OPERATION 225, a selected template 120 is downloaded from the template repository 118 and is stored in a project data store 108 associated with the project started at OPERATION 210. The user may then utilize the data and metadata 110 provided in the template 120 as resources for the project. According to an embodiment, the PDAM application 114 may perform one or more searches on a user's local computer and associated memory, as well as external or remote repositories for content that may be related to the project and selected project template. Knowledge of what template a user has selected may be helpful for finding suggestions of other information to put into the new project. For example, if a user has selected a template for planning a wedding, a suggested item might include a flower shop address found in the user's contacts list. A user may manually add content to a project's project data store. That content may be suggested to the user, wherein the user may accept or decline those suggestions. Content may include documents, emails, contacts, calendar items, etc.

The method ends at OPERATION 230.

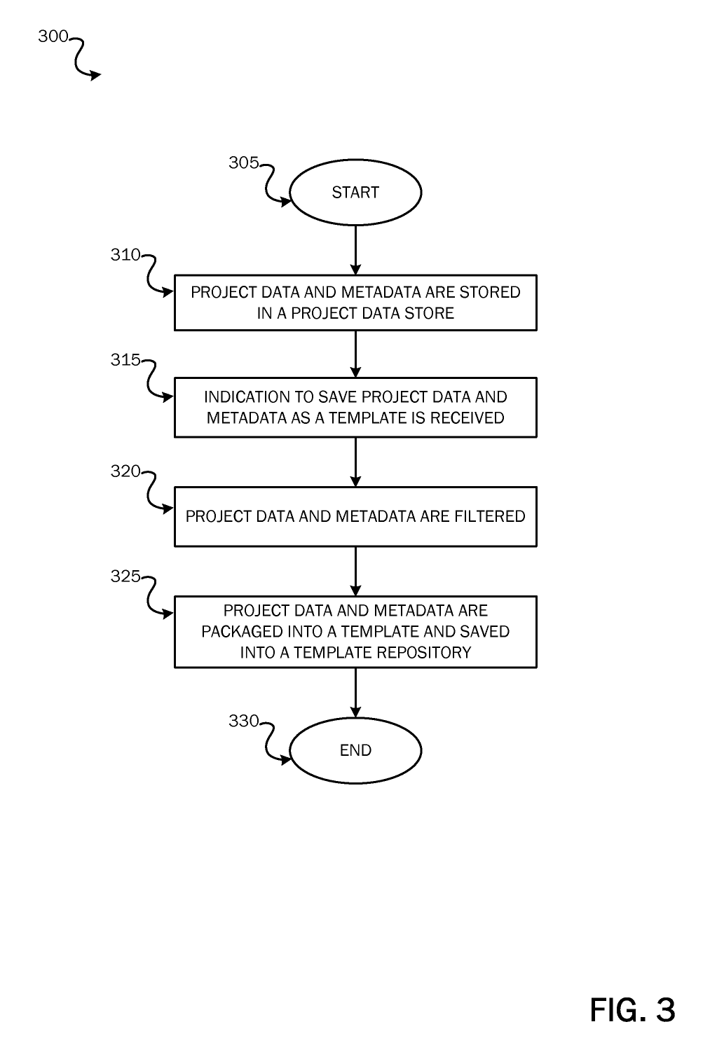

Referring now to FIG. 3, a process flow diagram of a method 300 for saving project data and metadata 110 associated with a project into a template will be described. The method starts at OPERATION 305, and proceeds to OPERATION 310, where project data and metadata 110 associated with a project are stored in a project data store 108. The project data and metadata 110 may include a project title, a project description, identification of one or more project team members, one or more links to other data stores, one or more identifications to information entities, features of interest extracted from information entities, and identifications and links to one or more software applications, as well as all other project content. For example, a link may be the unique identifications of an email item stored on an EXCHANGE server.

The method proceeds to OPERATION 315, where an indication to save project data and metadata 110 as a template is received. A user may choose to share information from a project. For example, referring back to the example of the wedding planning project described above, a user may choose to share a wedding planning template with another user who may be planning a wedding.

When an indication to save project data and metadata 110 as a template is received, at OPERATION 320, project data and metadata 110 may be filtered through a filtering module 122. Data that a user may not want to make public may be filtered out. That is, project data may be filtered out that should not be packaged into a template and stored in a template repository including any project data designated as private project data. For example, referring back to the above wedding planning project, addresses and personal information of the wedding project may be designated as private and may be filtered out when the project template is published to the repository for shared use. The project data may also be cleaned up before it is packaged into a template 120. According to an embodiment, a user may interact with the filtering module 122 to control what data item(s) 103 may be filtered.

After the project data and metadata 110 are filtered, at OPERATION 325, the project data and metadata 110 are packaged into a template and are saved into a template repository 118. When a template is stored in a template repository 118, it may be shared with other users. Other users may reuse the structure of the template 120, as well as the content contained within it. When a template is saved, an option may be provided to either download the template to a specified location (e.g., hard drive or network share), or to publish the template directly to a template library where other users may browse and download templates created by other users. According to another embodiment, a template 120 may be made available to another user through direct sharing.

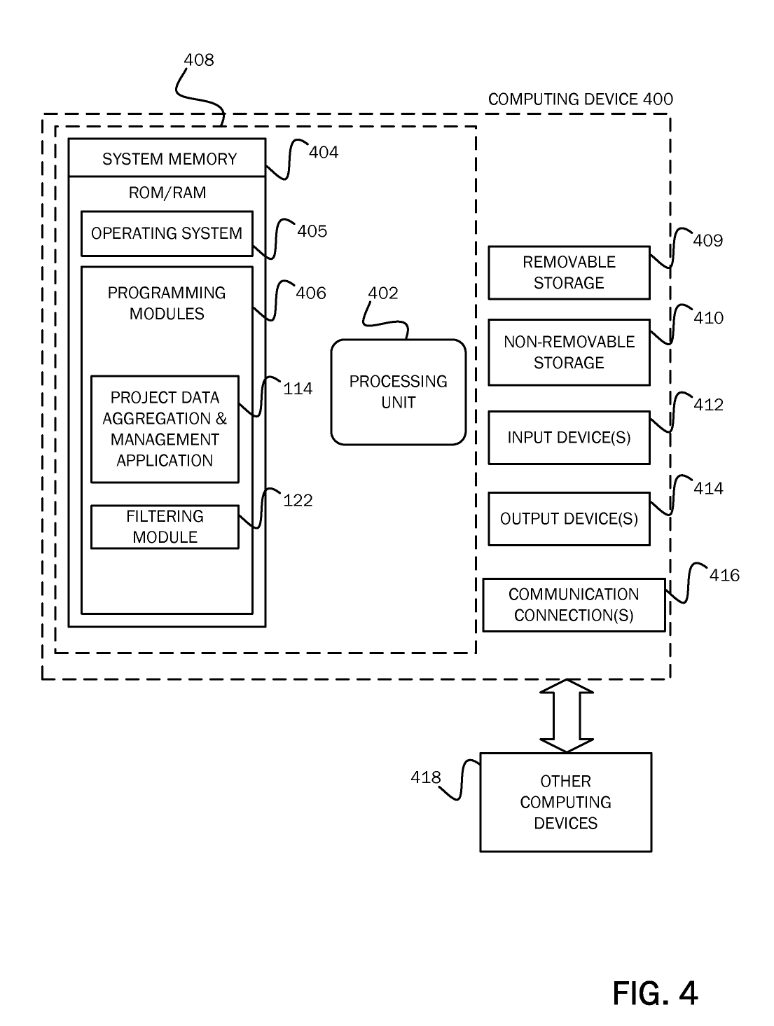

As described above, embodiments of the invention may be implemented via local and remote computing and data storage systems, including the systems illustrated and described with reference to FIGS. 1A and 1B. Consistent with embodiments of the invention, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any other computing devices 418, in combination with computing device 400, wherein functionality may be brought together over a network in a distributed computing environment, for example, an intranet or the Internet, to perform the functions as described herein. The aforementioned system, device, and processors are examples and other systems, devices, and processors may comprise the aforementioned memory storage and processing unit, consistent with embodiments of the invention. Furthermore, computing device 400 may comprise operating environment 100 as described above. Operating environment 100 is not limited to computing device 400.

With reference to FIG. 4, a system consistent with embodiments of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include project data aggregation and management application 407 and filtering module 122, wherein project data aggregation and management application 407 and filtering module 122 are software applications having sufficient computer-executable instructions, which when executed, performs functionalities as described herein. Operating system 405, for example, may be suitable for controlling computing device 400's operation. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computing device 400 may also contain a communication connection 416 that may allow device 400 to communicate with other computing devices 418, such as over a network in a distributed computing environment, for example, an intranet or the Internet. Communication connection 416 is one example of communication media.

As stated above, a number of program modules and data files may be stored in system memory 404, including operating system 405. While executing on processing unit 402, programming modules 406 (e.g. project data aggregation and management application 407) may perform processes including, for example, one or more of method 200's stages as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The term computer readable media as used herein may include computer storage media. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

We claim:

1. A method of providing a reusable package of project data and metadata, the method comprising:
storing project data and metadata associated with a given project in a project data store;
filtering project data and metadata for project data and metadata associated with a given project;
packaging filtered project data and metadata into a template; and
storing the template in a template repository.

2. The method of claim 1, wherein storing project data and metadata associated with a given project in a project data store includes storing one or more data types from one or more data sources associated with the given project.

3. The method of claim 2, wherein storing one or more data types from one or more data sources associated with the given project includes storing one or more of a project title, a project description, an identification of one or more project team members, one or more links to other data stores, one or more identifications to information entities, one or more features of interest extracted from information entities, and one or more identifications and links to one or more software applications.

4. The method of claim 1, wherein filtering project data and metadata for project data and metadata associated with a given project includes filtering out project data that should not be packaged into a template and stored in a template repository.

5. The method of claim 4, wherein filtering out project data that should not be packaged into the template and stored in the template repository includes withholding from the project data packaged into the template and stored in the template repository any project data designated as private project data.

6. The method of claim 1, wherein packaging filtered project data and metadata into a template includes packaging the metadata into a template in association with one or more software applications, the one or more software applications being operative to utilize the project data and metadata.

7. The method of claim 1, wherein the template repository is a shared repository.

8. A method of downloading a template for providing a reusable package of project data and metadata, the method comprising:
suggesting use of a given template based on metadata associated with a given project;
receiving an indication of a selection of a suggested template; and
copying project data and metadata stored within the template into a local data repository.

9. The method of claim 8, prior to suggesting use of a given template based on metadata associated with a given project,
storing project data and metadata associated with a given project in a project data store;
filtering project data and metadata for project data and metadata associated with the given project;
packaging filtered project data and metadata into a template; and
storing the template in a template repository.

10. The method of claim 8, wherein receiving an indication of a selection of a template includes receiving an indication of a selection of a template stored in a shared template repository.

11. The method of claim 8, wherein copying project data and metadata stored within the template into a local data repository includes copying project data and metadata of one or more data types from one or more data sources associated with the given project.

12. The method of claim 8, wherein the template is not associated with a particular application.

13. A computer-readable medium which stores a set of instructions which when executed performs a method for providing a reusable package of project data and metadata, the method comprising:
storing project data and metadata associated with a given project in a project data store;
filtering project data and metadata for project data and metadata associated with a given project;
packaging filtered project data and metadata into a template;
storing the template in a template repository;
receiving an indication of a selection of the template associated with the given project; and
copying project data and metadata stored within the template into a local data repository.

14. The computer-readable medium of claim 13, wherein storing project data and metadata associated with a given project in a project data store includes storing one or more data types from one or more data sources associated with the given project.

15. The computer-readable medium of claim 14, wherein storing one or more data types from one or more data sources associated with the given project includes storing one or more of a project title, a project description, an identification of one or more project team members, one or more links to other data stores, one or more identifications to information entities, one or more features of interest extracted from information entities, and one or more identifications and links to one or more software applications.

16. The computer-readable medium of claim 13, wherein filtering project data and metadata for project data and metadata associated with a given project includes filtering out project data that should not be packaged into a template and stored in a template repository.

17. The computer-readable medium of claim 16, wherein filtering out project data that should not be packaged into the template and stored in the template repository includes withholding from the project data packaged into the template and stored in the template repository any project data designated as private project data.

18. The computer-readable medium of claim 13, wherein packaging filtered project data and metadata into a template includes packaging the metadata into a template in association with one or more software applications, the one or more software applications being operative to utilize the project data and metadata.

19. The computer-readable medium of claim 18, wherein the template is software application agnostic.

20. The computer-readable medium of claim 13, wherein the template repository is a shared repository.
